(19) United States
(12) Patent Application Publication
(10) Pub. No.: US 2016/0188824 A1
(43) Pub. Date: Jun. 30, 2016

(54) HEALTHCARE DECISION SUPPORT SYSTEM FOR TAILORING PATIENT CARE

(71) Applicant: KONINKLIJKE PHILIPS N.V., Eindhoven (NL)

(72) Inventors: GIJS GELEIJNSE, GELDROP (NL); MICHAEL CHUN-CHIEH LEE, LEXINGTON, MA (US); JAN JOHANNES GERARDUS DE VRIES, EINDHOVEN (NL); ELKE MARIEKE LAMBERT DAEMEN, MEERHOUT (BE); ROEL PETER GEERT CUPPEN, VENLO (NL)

(21) Appl. No.: 14/906,921

(22) PCT Filed: Jul. 17, 2014
(86) PCT No.: PCT/EP2014/065321

§ 371 Date: Jan. 22, 2016

(30) Foreign Application Priority Data
Jul. 31, 2013 (EP) 13178700.4

(51) Int. Cl. G06F 19/00

(52) U.S. Cl. CPC G06F 19/345; G06F 19/322; G06F 19/3418

(57) ABSTRACT

A healthcare decision support system for tailoring patient care comprises a processor and a computer-readable storage medium, wherein the computer-readable storage medium contains instructions for execution by the processor causing the processor to perform the steps of obtaining media stimulation and feedback data of a patient in an adaptive healing environment, said media stimulation and feedback data including information on interactions of the patient with the adaptive healing environment, obtaining condition data of the patient, obtaining electronic health record data of the patient, evaluating the obtained data and determining a patient parameter including information on the patient set and providing the patient parameter set to a medical decision support component. The present invention further relates to a corresponding method and to a patient care system.

### FIELD OF THE INVENTION

The present invention relates to a healthcare decision support system for tailoring patient care, a corresponding method, a patient care system and a computer-readable non-transitory storage medium.

### BACKGROUND OF THE INVENTION

Clinical decision support systems (CDS) are more and more becoming an important factor in the standard patient care delivery. CDS are important components of clinical information technology systems and may directly improve patient care outcome and the performance of healthcare organizations. In particular the discharge management, i.e. the decision about when a patient can leave the hospital, is of high importance. Discharging the patient too early increases the risk of re-admission, which can cause higher overall costs for treatment and worsen the quality of life of the patient. On the other hand, requiring the patient to stay in the hospital although no further effect on his health situation or on the healing process is achieved results in unnecessary cost increase. The decision about the right discharge time among other decisions is currently mostly based on physiological measurements in combination with the experience of a physician.

In Jette et. al., “A Qualitative Study of Clinical Decision Making and Recommending Discharge Placement from the Acute Care Setting”, Journal of the American Physical Therapy Association, 2003, the authors study the decision-making process of physical therapists in a hospital when recommending discharge destinations for patients following acute care hospitalization. The decision-making process is analyzed and the authors find that decision-making is usually based on the therapists' experiences in combination with the healthcare teams' opinions and the corresponding healthcare regulations. Each decision considers the patient as an individual and the environment in which he lives.

It is difficult to map such an organic decision-making process to a technical system. Currently, most decisions are thus mainly based on the experience of the medical support personnel. The responsible physician uses his experience and his impression of the patient to estimate the level of self-care ability, the need for care arrangement, follow-up appointments and professional support.

One possible approach for representing this clinical decision process with a technical system such as a CDS is the use of large patient datasets to derive methods to access the patient's risk for adverse events, readiness for discharge and health progress in order to recommend an optimal time of discharge or further therapy.

There is thus a need for technical approaches to optimize patient care. In particular, optimizing and improving current CDS is one promising approach with respect to improving patient care.

Another development in the medical environment is the use of (adaptive or intelligent) healing environments in order to optimize the healing process of a patient. Such (adaptive or intelligent) healing environments make use of technical means to provide a context-related adaption of the environment in order to optimize the healing process for an individual patient in a patient room (individual or shared patient room). The healing process of a patient is affected by various environmental stimuli in the hospital. Studies have shown that the healing process can be improved and/or accelerated if the patient feels well in the clinical environment. There is, e.g., clear evidence for a positive effect of nature views on the healing process and/or on the tolerance level for pain, i.e. the required amount of pain medication. Furthermore, also exposure to daylight is found to be an important factor in the recovery process. Patients exposed to sufficient daylight are less stressed and usually need less pain medication. Bright (artificial) daylight exposure during day-time and avoidance of too much light exposure during night-time helps to sleep better at night and to feel more energized during the day. Especially a deep restorative and undisturbed sleep is of high importance for a fast recovery process in patients. The psychological condition of a patient (e.g. his alertness or state of mind) influences his current condition and the progress of the healing process.

The room situation in most hospitals does, however, often not allow assigning a room with a nice nature view or direct daylight to all patients. Further, patients being hospitalized during the winter are also exposed to less daylight. Still further, patient rooms may sometimes be situated on the lower levels of the hospital buildings with small windows or no windows at all. Such conditions may also be simulated by means of large screens and or other equipment in the adaptive or intelligent healing environment.

The Philips adaptive healing rooms project as disclosed e.g. in Harris, Klink, Philips Research, “Philips opens Hospital Research Area to develop innovative healing environments”, press release October 2011 aims to accelerate and improve treatment outcomes by means of adaptive or smart environment. For instance soothing lighting and calming video images and sounds can be used in a patient room in order to provide a specific atmosphere in the room. The patient or the physician can control some of the settings of the room. In WO 2012/176098 A1, there is presented an ambience creation system capable of creating an atmosphere in a patient room which doses the sensory load depending on the patient status, e.g. healing status such as the patient's condition, pain level, recovery stage or fitness. The atmosphere can be created by the ambience creation system capable of controlling lighting, visual, audio and/or fragrance effects in the room. The state of the atmosphere may be determined from sensor measurements, e.g. measurements of the patient's body posture, bed position, emotions or the amount of physical activity. The state of the atmosphere may also be determined from information retrieved from a patient information system which contains patient status information. Such a patient information system can either be kept up to date by the hospital staff or by data reported on by the patient itself as patient feedback e.g. on perceived pain level. The possibility of enhancing the healing process by means of context related adaption of the environment, i.e. an intelligent or adaptive environment, of a patient, i.e. the patient room, is explored. The intelligent environment may be controlled by the patient and/or by medical support personnel and adapted to the needs of the patient. An Adaptive Daily Rhythm Atmosphere (ADRA) thereby refers to a room or ambience being able to provide the necessary functionalities.

However, there is still large potential for improving patient care.

### SUMMARY OF THE INVENTION

It is an object of the present invention to provide a healthcare decision support system for improving the individual care for patients.

In a first aspect of the present invention there is presented a healthcare decision support system for tailoring patient care comprising a processor and a computer-readable storage medium, wherein the computer-readable storage medium contains instructions for execution by the processor causing the processor to perform the steps of obtaining media stimulation and feedback data of a patient in an adaptive healing environment, said media stimulation and feedback data including information on interactions of the patient with the adaptive healing environment, obtaining condition data of the patient, obtaining electronic health record data of the patient, evaluating the obtained data and determining a patient parameter set including information on the patient and providing the patient parameter set to a medical decision support component.

In a further aspect of the present invention there is presented a corresponding healthcare decision support method.

According to yet another aspect of the present invention there is presented a patient care system comprising an adaptive healing environment for accommodating a patient and for providing media stimulation and feedback data of the patient, said media stimulation and feedback data including information on interactions of the patient with the adaptive healing environment, a sensor for obtaining condition data of the patient, an electronic health record database including electronic health record data of the patient, a healthcare decision support system as described above and a medical decision support component for providing decision support to medical personnel and/or to the adaptive healing environment.

In yet another aspect of the present invention there is provide a non-transitory computer-readable storage medium that stores therein a computer program product, which, when executed by processor, causes the method disclosed herein to be performed.

Preferred embodiments of the present invention are defined in the dependent claims. It shall be understood that the claimed methods, processor, computer program and medium have similar and/or identical preferred embodiments as the claimed system and as defined in the dependent claims.

Current healthcare decision support systems mostly rely on physiological data such as vital data for providing medical decision support to physicians or technical systems. In modern hospital IT-solutions, vital data of a patient are stored in an individual electronic health record (EHR) together with reports of physicians or other medical personnel. All collected data are provided to the physician to support his decision-making. The physician can then use the stored EHR data along with his experience for coming to a decision, e.g. on the time of discharge or on the next treatment steps.

In contrast thereto, the system according to the present invention additionally obtains media stimulation and feedback data of a patient in an adaptive healing environment and condition data of the patient along with the EHR data. The data are jointly analyzed, evaluated and a patient parameter set is determined.

This patient parameter set thus comprises an increased amount of information in comparison to the data provided by previous clinical decision support systems or other support systems.

Current models for estimating a patient's risks to be used as input for the treatment plan, the estimation of discharge readiness or for the selection of an appropriate post-discharge care have low predictive value. Similarly, it is difficult to determine optimal settings of an adaptive healing environment for enhancing or optimizing the healing process of a person based on vital or health record data. This is generally thought to be caused at least partially by the use of an incomplete assessment of the patient's state as input for these models. The present invention allows overcoming these deficiencies by including more data and in particular media stimulation and feedback data of a patient in an adaptive healing room environment when determining the relevant parameters for the decision process. These media stimulation and feedback data may carry information on the psychological state of a patient, e.g. the alertness, the mental agility or also the general mood and the state-of-mind, i.e. the current feeling and prospect, of a patient. These data are usually not included in current healthcare decision support systems although potentially comprising relevant and meaningful information, which may allow drawing more accurate conclusions on the current status and/or the progress of the therapy of a patient. Thus, the present invention can help medical personnel to track the patient's progress and plan further treatment or the optimal time of discharge. The patient parameter set can thereby also be used as a predictor for the future development.

In contrast to previous systems, according to the present invention, healthcare decisions may be determined (partially) autonomously by a technical system requiring little input or no input at all from medical personnel. Thus, less intervention from medical personnel is required and processes in a hospital can be carried out more efficiently.

Further, the presented system may allow automatically determining parameters for the use in a medical decision support component. If, e.g., patients are to be discharged the automatic determination of a patient parameter set allows getting to an objective decision on his current situation, which may help to reduce the number of suboptimal decisions. Generally, medical decisions can be supported by providing and evaluating all data and determining a patient parameter set thereupon according to the present invention.

One advantage of the present invention is that all available data from all different available data sources may collected, evaluated and considered in the analysis in order to individualize and optimize the different decisions influencing the care and/or the treatment the patient receives.

Another advantage of the present invention may be that the information determination and distribution overhead in a clinical environment can be reduced in particular by providing information simultaneously to all involved personnel. Also including the media stimulation and feedback data of a patient in an adaptive healing environment in addition to the condition data and the electronic health record data allows increasing the reliability of the determined patient parameter set and the healthcare decisions based thereupon.

Yet another advantage of the present invention may be the provision of as much information as possible to any medical personnel connected to a central system. All medical support personnel being able to access a central system may access the relevant information and harmonize the individual care decisions with the care decisions of other personnel or currently determined information or parameters. Further, an easy exchange between care givers may be possible.

Yet another advantage of the present invention is that costs, in particular hospitalization costs, may be reduced.

According to a preferred embodiment of the present invention the computer-readable storage medium of the healthcare decision support system further comprises instructions causing the processor to perform a step of obtaining historic media stimulation and feedback data, condition data and/or electronic health record data of previous patients.

Thus, apart from information on the patient himself, also information on other patients, i.e. historical information, may be included in the analysis. A particular advantage of this embodiment is that the development and the progress of the current patient and his response to the treatment can be compared to similar cases, i.e. the patient parameter set can also be based on information relating to previous experiences. Such historic media stimulation and feedback data, condition data and/or electronic health data can either be obtained from the hospital's IT support system or from an inter-hospital IT system providing information collected in different hospitals or in medical research facilities.

According to another embodiment of the present invention the media stimulation and feedback data are collected by context sensors in the adaptive healing environment.

One advantage of collecting media stimulation and feedback data by means of context sensors in the adaptive healing environment may be that no direct input from the patient or from the medical support personnel is required. All data are collected autonomously. Another advantage is that the patient behavior does not need to be affected in any way. The patient can just behave normal and the necessary data are obtained parasitically or automatically.

According to another embodiment of the present invention the media stimulation and feedback data include at least one of interaction times of the patient with the adaptive healing environment, interaction frequency of the patient with the adaptive healing environment and the patient's choice of settings of the adaptive healing environment. It is particularly interesting for deriving information about the alertness, state of mind and/or psychological state of a patient to evaluate how he interacts with the adaptive environment.

Further, the media stimulation and feedback data can also include the interaction frequency of the patient with the adaptive healing environment, i.e. how often the patient uses or changes the environment settings. A high frequency might be indicative of a nervous patient, whereas a low frequency might be indicative of a patient feeling unwell. This information usually needs to be put into the appropriate context. Still further, it can also be determined which kind of settings the patient chooses for his individual environment.

It is however important to mention that it is not necessarily relevant to interpret the obtained data at this point. The data are merely collected but interpreted and evaluated at a later stage. All information is collected and fed back to the healthcare decision support system by which it is then evaluated in conjunction with the other obtained data and the patient parameter set is determined.

In another embodiment of the present invention the condition data of the patient are collected by means of on-body sensors attached to the patient. Such on-body sensors might be wireless sensors connected via Wi-Fi, Bluetooth, ZigBee or other wireless standards. It is also possible that the sensors are connected via wires with one or multiple interface units providing the sensor readings to the healthcare decision support system. It may also be necessary to additionally include a central data collection station, e.g. a wireless coordinator device, which collects the condition data from the different on-body sensors, maybe performs a preprocessing step, and forwards all data to the healthcare decision support system as described above. A particular advantage of this embodiment is that different types of on-body sensors can be used for collecting the condition data. It is also possible to design an appropriate interface for connecting sensor devices of other vendors and/or sensors operating with different communication standards with the healthcare decision support system according to the present invention. Preferably, however, the condition data are collected by means of a standard wireless sensor network and provided to the healthcare decision support system via a single dedicated router device. Several sensor nodes may be attached to the patient at different spots.

According to yet another embodiment of the present invention the condition data include at least one of heart-rate, blood oxygenation, breathing frequency, activity, blood pressure, temperature or other vital parameters. In order to provide these data the appropriate sensors are used. The sensors might thereby include inertial sensors such as an acceleration sensor for determining the activity of the patient, optical sensors for determining blood oxygenation, breathing frequency, blood pressure, heart rate, temperature, various capacitive sensors or also any other types of sensors. According to this embodiment condition data particularly refer to vital parameters of the patient preferably collected in real-time. Further preferably, these real-time data are collected by means of wireless on-body sensors and wirelessly communicated to the healthcare decision support system via a suitable interface device.

According to another preferred embodiment of the present invention the electronic health record data include information on at least one of blood lab values, prescribed medication, symptoms, co-morbidities and medical history. Such information can for example be entered into the system by the medical personnel or also by the patient himself. An electronic health record might include information on the entire medical history of the patient, i.e. date back to a time prior to hospitalization (or even date back to the time a patient was born in extreme cases). It is also possible to include information collected by the general practitioner treating the patient before the patient was hospitalized. In comparison to the mentioned condition data the electronic health record data thereby particularly include information that cannot be determined by means of a sensor but rather needs to be manually provided by the medical personnel. Again, it is important to mention that different medical personnel can simultaneously provide different electronic health record data for one patient. Depending on the amount of available information, the healthcare decision support system can determine different patient parameters based thereupon.

In a preferred embodiment of the present invention the patient parameter set includes at least one of a parameter being indicative of the state-of-mind of a patient, a parameter being indicative of the alertness of a patient, information on the resting patterns of a patient, information on the readiness for discharge of a patient, a patient health score indicative of the progress of the therapy of the patient and information on the risk for adverse events. Based on this information, the medical support personnel may be able to faster and more reliably come to a conclusion about the current state of a patient and suitable next actions.

According to another preferred embodiment of the present invention evaluating the obtained data and determining the patient parameter set includes comparing the obtained data to historic media stimulation and feedback data, condition data and/or electronic health record data of previous patients and determining irregularities. If reference data of previous patients, i.e. historic media stimulation and feedback data, condition data and/or electronic health records data, are available, these can be used for deriving the differences between the state and the behavior of the current patient in comparison to previous cases. This way, experiences with previous patients can be incorporated into the healthcare decision support system according to the present invention. One advantage compared to former decision support systems is that including data of previous patients allows incorporating the experience without requiring extensive input from one or multiple physicians. If, e.g., it is determined that a patient moves less or less frequent than a comparable patient suffering from the same disease, this might be an indication that the healing process is not optimal at the moment. Further, if a patient seems to interact with the intelligent environment a lot more than a previous patient this might be indicative of a higher alertness of this patient. However, the differences between the current data and the historic media stimulation and feedback data, condition data and/or electronic health record data have to be interpreted with care.

According to another embodiment of the present invention evaluating the obtained data and determining the patient parameter set includes using machine learning algorithms based on the obtained data and the historic media stimulation and feedback data, condition data and/or electronic health record data of previous patients. One possibility to determine the patient parameter set is to make use of machine learning algorithms. Machine learning refers to algorithms that function based on learning from data. The algorithm is trained based on available data, e.g. historical data or data obtained until a specific moment in time, in order to predict the behavior of the data in the future. If, e.g., data of previous patients and the outcomes of the therapies are available, a machine learning algorithm can be trained such that it recognizes similarities to currently obtained data of a current patient and then predict a comparable outcome for a specific therapy of the current patient. Learning may thereby refer to a dedicated training phase in which the algorithm is fed with previously recorded data or to an online learning approach, where the algorithm is trained while evaluating incoming data. The predictions can then be included in the patient parameter set and fed back to the medical decision support component.

One particular advantage in contrast to previous approaches to applying machine learning algorithms is that additionally the obtained media stimulation and feedback data of an adaptive healing environment are used. Previous approaches do not take such data into account. By including this additional information, the information content of the determined patient parameter set and the prediction accuracy may be increased.

According to yet another preferred embodiment of the present invention the medical decision support component comprises a healing environment decision component for controlling the settings of an adaptive healing environment based on the patient parameter set and/or on input from medical support personnel. In this embodiment the obtained patient parameter set is used as an input to a technical system, i.e. the adaptive healing environment. The parameters of the adaptive healing environment, e.g. the settings of the screens, the illumination, the acoustic stimulation etc., are directly adapted based on the determined patient parameters. If, e.g., a patient is observed to react positively to acoustical stimulation there could be provided such acoustical stimulation in regular intervals. It is thereby possible to make use of a closed-loop control in which only the determined patient parameters are used for configuring the adaptive healing environment. Alternatively, it is also possible to make use of an open-loop control system where additionally the input from medical support personnel and/or from the patient himself is considered in the configuration of the adaptive healing environment. An advantage of such a control is that the complexity of the setting can be decreased.

According to yet another preferred embodiment of the present invention the medical decision support component comprises a clinical decision support component for providing decision support to medical personnel. Thus, the determined patient parameters are directly fed back to the treating physicians and nurses so that they can adapt the current therapy or medication. If, e.g., the patient is determined to be in a bad mood or in a bad state-of-mind this might not be the right time for an exhausting or stressful treatment procedure. One particular advantage of this embodiment of the present invention is that all available information is used and provided to the medical support personnel to optimize patient care.

### BRIEF DESCRIPTION OF THE DRAWINGS

These and other aspects of the invention will be apparent from and elucidated with reference to the embodiments described hereinafter. In the following drawings

FIG. 1 shows a schematic illustration of an embodiment of a healthcare decision support system according to the present invention;

FIG. 2 shows an embodiment of a healthcare decision support method according to the present invention;

FIG. 3 shows an illustration of a patient in an adaptive healing environment;

FIG. 4 illustrates a patient care system according to the present invention comprising a healthcare decision support system;

FIG. 5 illustrates another embodiment of a healthcare decision support system according to the present invention;

FIG. 6 illustrates another embodiment of a patient care system according to the present invention; and

FIG. 7 shows an illustration of an adaptive healing environment.

### DETAILED DESCRIPTION OF THE INVENTION

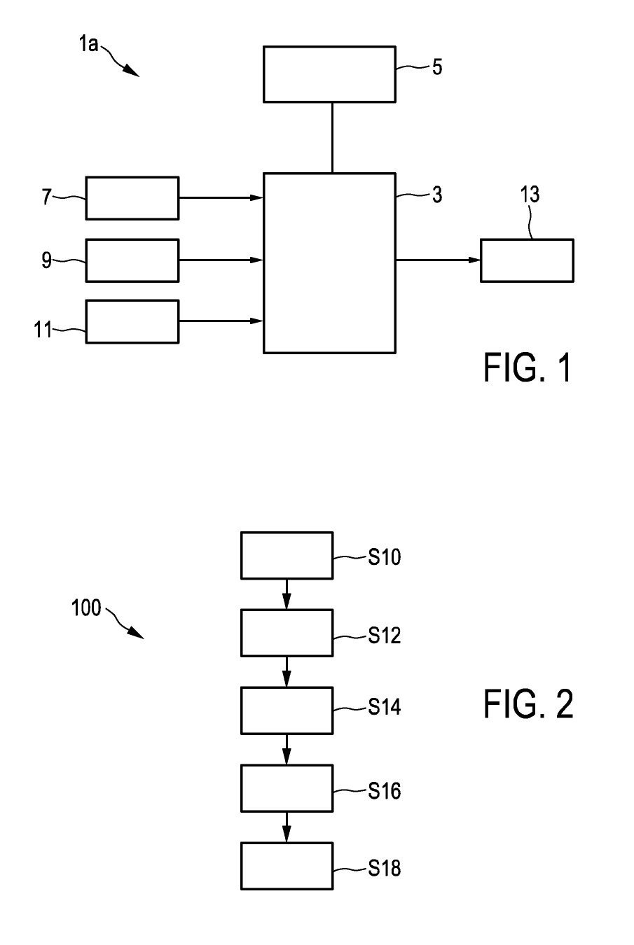

In FIG. 1, there is illustrated a schematic diagram of a first embodiment of a healthcare decision support system 1a according to the present invention. The system comprises a processor 3 and a computer-readable storage medium 5. This computer-readable storage medium 5 contains instructions for execution by the processor 3. These instructions cause the processor 3 to perform the steps of a healthcare decision support method 100 as illustrated in the flow chart shown in FIG. 2.

In a first step S10, media stimulation and feedback data 7 of a patient in an adaptive healing environment are obtained. In a second step S12, condition data 9 of that patient are obtained. Further, electronic health record data 11 are obtained at step S14. All obtained data are evaluated S16 and a patient parameter set 13 is determined. The patient parameter set 13 is provided S18 to a medical decision support component.

Thereby the steps S10, S12 and S14 can also be carried out in another sequence. In the illustrated embodiment of the present invention, the obtained media stimulation feedback data 7 of a patient are collected in an adaptive healing environment, i.e. an intelligent environment, providing interaction and feedback means for patients being stationed therein as well as means for generating a mood or atmosphere in the room.

The obtained media stimulation and feedback data 7 may thereby refer to data captured in an adaptive healing environment. These data can comprise information on the setting of the room (e.g. light level, temperature, . . . ) as well as all different kinds of interaction of the patient with the room or equipment in the room (e.g. media usage, change of light settings, open/close the window, . . . ) initiated by the patient and/or by the room. Condition data 9 refer to all data relating to the current condition of the patient being captured by sensors or entered by medical personnel (e.g. real-time vital data captured by vital sensors, light reflex measurements conducted by medical support personnel, . . . ). The electronic health record data 11 refers to all data comprised in the electronic health record such as previous treatments and medication, diagnosis, previously recorded vital signs or vital data or any kind of other support information.

In the context of the present invention an adaptive healing environment particularly refers to an intelligent environment or patient room including at least one of one or more remotely controllable programmable screens for displaying images or videos, remotely controllable adjustable artificial lightning means for inducing various light moods in the room, remotely controllable shutters and/or curtains at the windows, a remotely controllable bed, visual and acoustical stimulation means, remotely controllable windows, media entertainment and information systems and various other technologies or technical means.

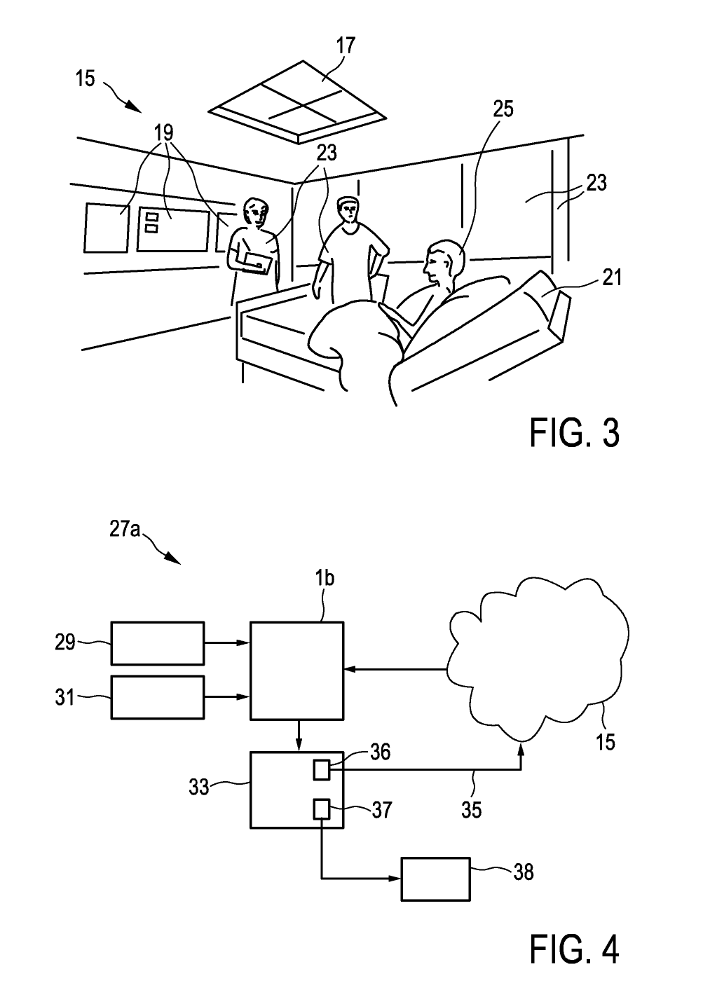

FIG. 3 illustrates an example of such an adaptive healing environment 15. In the illustrated adaptive healing environment 15, there is comprised a remotely controllable adjustable artificial overhead light 17, which can be configured to illuminate the patient room at different light-levels corresponding to different scenes and in different colors. There are further provided different remotely controllable screens 19 for displaying images or videos. These screens 19 can, e.g., be configured to display images of a nature scene such as a rain forest or a mountain area. The adaptive healing environment 15 may also comprise an automatic motorized patient bed 21 for supporting the patient, which is also remotely controllable. Still further, the patient room may comprise automatic and remotely controllable curtains and windows 53.

The remotely controllable equipment in the room can be controlled by means of a patient remote control depending on the settings defined by the medical support personnel 23. For instance, the medical support personnel 23 could choose one of the settings low, medium or high indicative of the level of stimulation being provided to the patient by the adaptive healing environment 15. Thus, even if the patient 25 selects a certain setting of the adaptive healing environment 15, i.e. of the different support systems or other technical means within his environment, the settings are still overruled by the definitions of the medical support personnel 23. If, for instance, the patient 25 chooses a dark adapted illumination, he might not be able to maintain this setting during the day. Further, if, e.g., a patient interacts with the adaptive healing environment by selecting a bright illumination level in the middle of the night, this might be a sign of sleeplessness or a high level of excitement. If, e.g., a patient always prefers the room to be configured in a way that illumination is low, windows are closed and any kind of visual or acoustical stimulation is switched off in the middle of the day at a highly active time, this might indicate that the patient is not in a good mood or feels unwell. A wide range of interpretations of the interaction times of the patient with the adaptive healing environment are possible.

It is one goal of the present invention to enhance the healing process of a patient in an adaptive healing environment by means of a context-related adaption of the environment. It is further a goal of the present invention to provide information to medical personnel on the current well-being of the patient in order to optimally prepare the patient for discharge or to determine the optimal time for discharge. The patient 25 in the adaptive healing environment 15 illustrated in FIG. 3 interacts with this environment 15. According to the present invention, these interactions are evaluated and aspects, such as the patient's alertness and state-of-mind, are assessed.

In contrast to known clinical decision support systems, which mostly rely on physiological data, e.g. condition data or electronic health record data, the present invention also models interaction data, i.e. media stimulation and feedback data, when determining information on the patient, i.e. the patient parameter set. The patient parameter set may include, e.g., a patient health score indicative of the progress of the therapy of a patient. Based on this patient parameter set, it is one goal of the present invention to determine suitable settings for an adaptive healing environment in order to provide an optimally adjusted environment and support the healing process of a patient. Further, the present invention aims at supporting physicians when taking clinical decisions, e.g. when determining the time a patient is discharged, by providing reliable data and decision support.

Based on all different data, a patient parameter set is then determined, comprising the results of an evaluation or analysis of the obtained data. This patient parameter set is provided to a medical decision support component, i.e. a technical decision support means, for the use in a hospital. Such a medical decision support component can thereby in particular refer to a simple computer screen displaying information and recommendations for medical support personnel, to an inter- or intra-hospital network distributing such information to other physicians, to a technical system directly processing the information in order to determine possible adaptions of the care plan of a patient or to a technical system for adapting the intelligent environment. Also, a prognosis of a future status of a patient can be based on the obtained data and comprised in the patient parameter set.

Depending on the obtained media stimulation and feedback data, condition data and electronic health record data the patient parameter set is determined. Depending on the intended use of said patient parameter set, different information can be included therein. Also, various forms of information are possible. A parameter being indicative of the state-of-mind of a patient might just be represented by a percentage value or an arbitrary unit-free figure normalized to a specified range. The same holds for a parameter being indicative of the alertness of a patient. Information on the resting patterns of a patient can particularly refer to the times the patient switches off the light, does not use any of the technical means comprised in the adaptive healing environment or stays in his bed.

It may be complicated to determine information on the readiness for discharge of a patient. Such information may be represented by a unit-free figure or by a percentage value possibly accompanied by a confidence interval. Comparably thereto, a patient health score may be determined indicating the progress of the therapy of a patient such that medical personnel can directly deduce the current state of the patient by analyzing a single figure. Such a patient health score might be a first indication for medical personnel needing to access and evaluate the condition of a high number of patients every day. The information on the risk for adverse events may particularly refer to a parameter possibly also accompanied by a confidence value indicating how likely it is that the patient suffers from a sickness which has not yet been recognized or how likely it is that the patient needs to be readmitted to the hospital after discharge. Further patient parameters are thinkable and can also be processed by the healthcare decision support system according to the present invention.

One embodiment of a patient care system 27a according to the present invention is illustrated in FIG. 4. The patient care system 27a comprises a healthcare decision support system 1b according to the present invention. The patient care system 27a further comprises an adaptive healing environment 15 for accommodating a patient and for providing media stimulation and feedback data of the patient. The patient care system 27a also comprises a sensor 29 for obtaining condition data of the patient. The sensor 29 may particularly be an on-body sensor attached to the body of the patient. Examples of such on-body sensors for determining condition data for a patient include heart rate sensors, blood oxygenation sensors, breathing frequency sensors, activity sensors, blood pressure sensors, temperature sensors or other vital sign sensors. The sensor 29 obtains such condition data and provides them to the processor comprised in the healthcare decision support system 1b. The patient care system 27a further comprises an electronic health record database 31 including electronic health record data, i.e. medical data, of the patient. Such an electronic health record database 31 could, e.g., include information on blood lab values, medication, symptoms, comorbidities and medical history of the patient. In contrast to the previously described condition data of the patient, the data comprised in the electronic health record database 31 rather refer to parameters determined by medical support personnel than to raw sensor data. Thus, the electronic health record data could be interpreted as metadata representing interpretations and deductions of medical support personnel.

FIG. 4 further illustrates that the determined patient parameter set is provided by the healthcare decision support system 1b to a medical decision support component 33. This medical decision support component 33 in turn makes use of the determined patient parameter set in a twofold way. Firstly, according to the illustrated embodiment, a closed-loop control 35 is applied to the adaptive healing environment 15 in that the outcome of the decision support component, i.e. the patient parameter set, is directly influencing one of its data sources. A healing environment decision component 36 comprised in the medical decision support component 33 is used for controlling the settings of the adaptive healing environment 15 based on the determined patient parameter set. It would further be possible that, apart from the determined patient parameter set, also input from medical support personnel is considered for controlling the settings of the adaptive healing environment 15. With respect to the adaptive healing environment 15, the illustrated example, however, illustrates a control wherein only the patient parameter set determined by the healthcare decision support system 1a is used for configuring the adaptive healing environment 15.

According to the example illustrated in FIG. 4, the medical decision support component 33 further comprises a clinical decision support component 37 for providing decision support to medical support personnel. This clinical decision support component 37 may, e.g., be disposed as a tablet computer communicating via a WiFi network with an appropriate server and may be configured for use by a nurse. This tablet may provide a user interface for controlling the functionalities in the adaptive healing environment 15 and/or an information interface for the medical personnel.

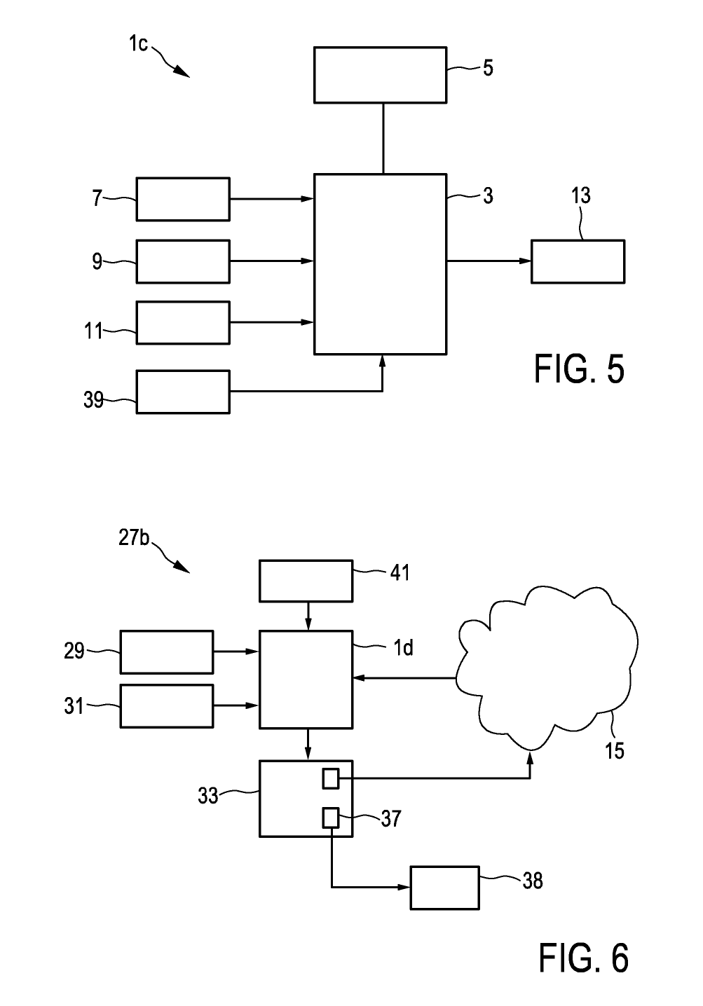

In FIG. 5 there is illustrated another embodiment 1c of a healthcare decision support system according to the present invention. The healthcare decision support system 1c comprises a processor 3 and a computer readable storage medium 5. The processor 3 obtains media stimulation and feedback data 7, condition data 9 and electronic health record data 11 of a patient. Furthermore, the processor 3 also obtains historic media stimulation and feedback data, condition data and/or electronic health record data of previous patients 39. Such historic data 39 essentially refer to data of other patients with a comparable medical history like the currently treated patient. Such patients could, e.g., be patients in another medical care facility or previous patients in the same medical care facility. The historic data 39 are taken into account when determining the patient parameter set 13.

As illustrated in FIG. 6, a patient care system 27b including a healthcare decision support system 1d according to the present invention comprises a sensor 29, an appropriate electronic health record database 31, an adaptive healing environment 15 and a medical decision support component 33. As outlined above, the medical decision support component 33 comprised in the illustrated embodiment of the patient care system 27b includes both a clinical decision support component 37 for providing decision support to medical personnel, e.g. by means of a computer interface such as a wireless tablet computer device 38, and a healing environment decision component 36 for controlling the settings of an adaptive healing environment 15 based on the patient parameter set. Optionally, such a medical decision support component 36 could also be configured to allow controlling the settings of the adaptive healing environment 15 based on input from medical support personnel.

In FIG. 6, there is further illustrated a hospital database 41 wherein historic data, i.e. historic media stimulation feedback data, condition data and/or electronic health record data of previous patients, are stored. Optionally, instead of a hospital database 41, these data may also be provided from a cloud database through some kind of network connection. Such a network connection, i.e. a wireless or wired intranet or internet connection, would allow additionally including data from patients in other medical care facilities.

The available data may be used as training data in a machine learning algorithm, which autonomously and without requiring the determination of fixed input/output relations allows using the available information for predicting the outcome of the therapy of a current patient. For this, patient data of previous patients are fed into such an algorithm along with data on the outcome of the therapy. The algorithm then automatically determines the significance of the different data for predicting the development of the patient in response to the therapy he receives. Depending on the available data, the information content of condition data, electronic health record data and/or media stimulation and feedback data varies. This process of determining the input and output of the algorithm based on previously available (training) data, i.e. data of previous patients, is usually referred to as training or learning phase. After this training or learning phase, the knowledge, i.e. the algorithmic approach, can be applied to currently acquired data, i.e. data of a patient currently under treatment, in order to predict a likely outcome of the therapy or further progress of the therapy. One advantage of this approach is that no direct input/output model, e.g. a linear relationship, needs to be constructed, but the machine learning algorithm automatically configures itself to provide reasonable deductions based on the obtained data.

According to the present invention, the available data are used in the training phase. The resulting trained machine learning algorithm is then used to determine the patient parameter set. It is thereby possible to use all or only a subset of the available historic condition data, electronic health record data and/or media stimulation and feedback data of previous patient in the training phase. Further, it is also possible to use all or only a subset of the obtained condition data, electronic health record data and/or media stimulation and feedback data of a current patient in an adaptive healing environment in order to determine the patient parameter set.

After the training phase, such a machine learning algorithm is able to process the currently obtained data, i.e. the media stimulation and feedback data, condition data and electronic health record data and to determine therefrom a prediction for the current patient. Possible machine learning algorithms thereby include, but are not limited to clustering, support vector machines, patient networks, re-enforcement learning, representation learning, similarity and metric learning, sparse dictionary learning, support vector machines, inductive logic programming, decision tree learning, association rule learning and artificial neural networks.

In comparison to previous approaches, according to the present invention also the media stimulation and feedback data may be considered during the training phase and/or during the processing phase. Such media stimulation and feedback data may, e.g., include interaction times of patient with the adaptive healing environment, interaction frequency of the patient with the adaptive healing environment and the patient's choice of settings of the adaptive healing environment. As outlined above, depending on how the patient interacts with the adaptive healing environment, these media stimulation and feedback data can comprise information on parameters such as the state of mind or the alertness of a patient. These parameters might be indicative of the progress of the healing process.

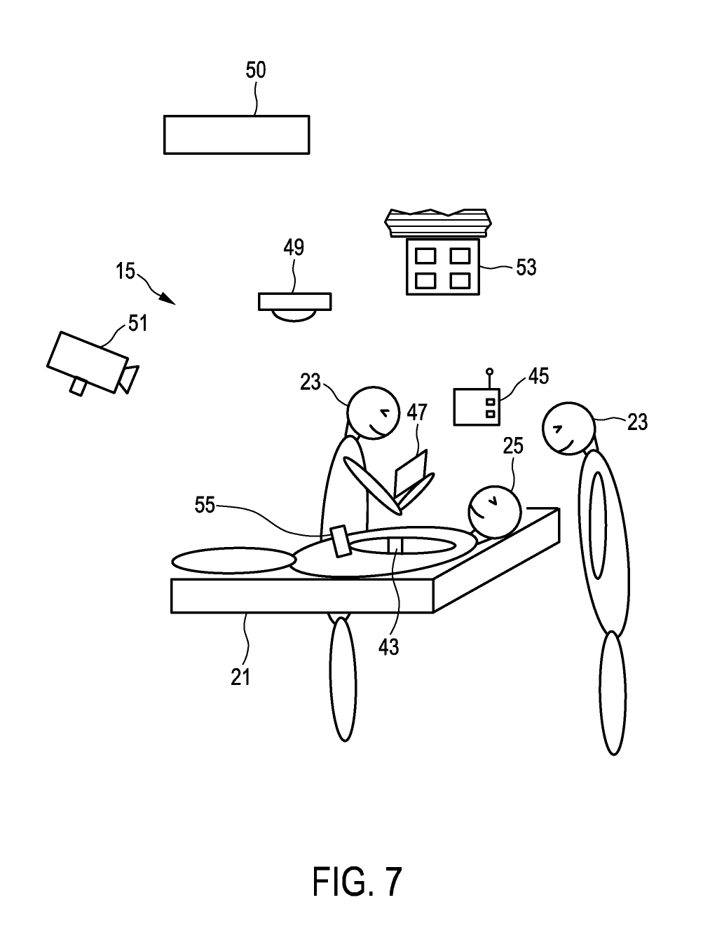

In FIG. 7, there is illustrated a patient 25 in an adaptive healing environment 15. The patient 25 lies on an electronically controllable patient bed 21 and wears an on-body sensor 29 for determining his heart rate and blood pressure. In the illustrated example, this on-body sensor 29 is a simple bracelet device being attached to the arm of the patient 25 and communicating wirelessly with a coordinator device 45. As illustrated in FIG. 7, this coordinator device 45 might be mounted to the wall of the room and be connected to a hospital network. Further, the medical support personnel 23 taking care of the patient 25 makes use of a tablet computer device 47 which is also configured to wirelessly communicate with the coordinator device 45. This tablet computer device 47 allows the medical support personnel 23 to assess data, i.e. condition data, media stimulation feedback data and electronic health record data of the patient.

In FIG. 7, there is further illustrated an infra-red motion and light detector 49, a camera sensor 51 and an electronically controllable window 53 including an electronically controllable roller shutter. All devices also communicate their obtained data to the coordinator device 45 and are configured to be controlled by the coordinator device 45. The patient 25 holds a remote control 55 which, according to the illustrated example, can also communicate wirelessly with the coordinator device 45. This remote control 55 allows the patient 25 to control the actuators in the adaptive healing environment 15. In the illustrated example, he particularly controls the electronically controllable window 53 and the adjustable artificial light 50.

It may also be possible that medical support personnel 23 has the option to select from a limited number of settings such as low, medium and high referring to the amount of stimulation a patient 25 in the adaptive healing room 15 will be subject to. Within a setting chosen by the staff, the patient 25 is then free to control and select therefrom the number of elements that are offered within this setting such as, e.g., light, sound and scenes. For instance, patients could be allowed to control the light settings during visiting hours but can't overrule the daily rhythm imposed by the system or the setting low, medium or high imposed by the staff. It can thereby be flexibly configured which part of the environment is directly (automatically) adapted based on the determined patient parameters and which part or to which extent the adaptive healing environment is configured based on the input of medical support personnel or patients.

According to an embodiment of the present invention, it is registered how often the patient 25 interacts with the adaptive healing environment 15 and what kind of settings he chooses. These data in combination with the acquired data of the on-body sensor 29 are evaluated by the healthcare decision support system, which is also comprised in the coordinator device 45 in the example illustrated in FIG. 7. The healthcare decision support system provides a patient parameter set to a medical decision support component. In the illustrated example, such a medical decision support component could also be physically included in the coordinator device 45 and could provide a web interface being accessible by the medical support personnel 23 by means of the tablet computer device 47. The patient parameter set may include a parameter being indicative of the state of mind or the alertness of a patient 25, which, in turn, may help the medical support personnel 23 to determine whether the patient 25 is ready for discharge. Further, the coordinator device 45 and the therein included medical decision support component may also comprise a healing environment decision component which can control the settings of the adaptive healing environment 15. For instance, the light setting or another parameter might be directly adjusted in response to the determined patient parameter set.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

In the context of the present application context sensors for obtaining the relevant information, in particular the media stimulation and feedback data may include motion detectors, cameras, illumination detectors, microphones, sensors attached to a television remote control, sensors attached to a remote control for controlling the intelligent environment, temperature sensors, humidity sensors or further sensor devices that can be applied in a patient room. Furthermore, context information can directly be obtained from media and/or IT systems, e.g. by means of a network connection to a computer or television. A context sensor is then represented by an already available technical system in the adaptive patient room for which the data are obtained. Depending on the amount of collected data the derivable information increases. The more data are provided and sent back to the healthcare decision support system (i.e. media stimulation and feedback data) the more information can be derived.

In the context of the present application medical support personnel can refer to physicians, nurses, technical personnel in a clinic, care givers, physical therapists, family members taking care of the patient or anyone else concerned with the healing process of a patient in a hospital.

A computer-readable storage medium as used herein may refer to any storage medium, which may store instructions executable by a processor, a controller or a computing device. This computer-readable storage medium may also be referred to as computer-readable non-transitory storage medium. In some embodiments, such a computer-readable storage medium may also be able to store data, which can be accessed by the processor, controller or computing device. Examples of computer-readable storage mediums include, but are not limited to: a floppy disc, a magnetic hard disc drive, a solid state hard disc, flash memory, a USB flash drive, random access memory, read only memory, an optical disc, a magneto-optical disc and the register file of the processor. Examples of optical discs include compact discs, digital versatile discs, e.g. CD-Rom, DVD-RW, DVD-R or Blue-Ray discs. The term computer-readable storage medium may also refer to various types of media capable of being accessed by a processor or computer device via a network or communication link, e.g. over a modem, over the internet or over a local area network. A computer program may be stored/distributed on a suitable non-transitory medium, such as an optical storage medium or a solid-state medium supplied together with or as part of other hardware, but may also be distributed in other forms, such as via the Internet or other wired or wireless telecommunication systems.

A processor as used herein comprises an electronic component which is able to execute a program or machine-executable instructions. A computer device or a computer system can comprise more than one processor. A computer device might further comprise a screen, a human machine interface and other components.

Furthermore, the different embodiments can take the form of a computer program product accessible from a computer usable or computer readable medium providing program code for use by or in connection with a computer or any device or system that executes instructions. For the purposes of this disclosure, a computer usable or computer readable medium can generally be any tangible device or apparatus that can contain, store, communicate, propagate, or transport the program for use by or in connection with the instruction execution device.

In so far as embodiments of the disclosure have been described as being implemented, at least in part, by software-controlled data processing devices, it will be appreciated that the non-transitory machine-readable medium carrying such software, such as an optical disk, a magnetic disk, semiconductor memory or the like, is also considered to represent an embodiment of the present disclosure.

The computer usable or computer readable medium can be, for example, without limitation, an electronic, magnetic, optical, electromagnetic, infrared, or semiconductor system, or a propagation medium. Non-limiting examples of a computer readable medium include a semiconductor or solid state memory, magnetic tape, a removable computer diskette, a random access memory (RAM), a read-only memory (ROM), a rigid magnetic disk, and an optical disk. Optical disks may include compact disk-read only memory (CD-ROM), compact disk-read/write (CD-R/W), and DVD.

Further, a computer usable or computer readable medium may contain or store a computer readable or usable program code such that when the computer readable or usable program code is executed on a computer, the execution of this computer readable or usable program code causes the computer to transmit another computer readable or usable program code over a communications link. This communications link may use a medium that is, for example, without limitation, physical or wireless.

A data processing system or device suitable for storing and/or executing computer readable or computer usable program code will include one or more processors coupled directly or indirectly to memory elements through a communications fabric, such as a system bus. The memory elements may include local memory employed during actual execution of the program code, bulk storage, and cache memories, which provide temporary storage of at least some computer readable or computer usable program code to reduce the number of times code may be retrieved from bulk storage during execution of the code.

Input/output, or I/O devices, can be coupled to the system either directly or through intervening I/O controllers. These devices may include, for example, without limitation, keyboards, touch screen displays, and pointing devices. Different communications adapters may also be coupled to the system to enable the data processing system to become coupled to other data processing systems, remote printers, or storage devices through intervening private or public networks. Non-limiting examples are modems and network adapters and are just a few of the currently available types of communications adapters.

The description of the different illustrative embodiments has been presented for purposes of illustration and description and is not intended to be exhaustive or limited to the embodiments in the form disclosed. Many modifications and variations will be apparent to those of ordinary skill in the art. Further, different illustrative embodiments may provide different advantages as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated. Other variations to the disclosed embodiments can be understood and effected by those skilled in the art in practicing the claimed invention, from a study of the drawings, the disclosure, and the appended claims.

1. A healthcare decision support system for providing a patient parameter set for tailoring patient care, said system comprising a processor, a computer-readable storage medium and interface: means for obtaining media stimulation and feedback data, condition data and electronic health record data of a patient in an adaptive healing environment,
wherein the computer-readable storage medium contains instructions for execution by the processor causing the processor to perform the steps of
obtaining media stimulation and feedback data of the patient;
obtaining condition data of the patient;
obtaining electronic health record data of the patient;
evaluating the obtained data and determining a patient parameter set including information on the patient; and
providing the patient parameter set to a medical decision support component;
characterized in that said media stimulation and feedback data include information on interactions of the patient with the adaptive healing environment.

2. The healthcare decision support system according to claim 1, wherein the instructions further cause the processor to perform a step of obtaining historic media stimulation and feedback data, condition data and/or electronic health record data of previous patients.

3. The healthcare decision support system according to claim 1, wherein the media stimulation and feedback data are collected by context sensors in the adaptive healing environment.

4. The healthcare decision support system according to claim 1, wherein the media stimulation and feedback data include at least one of
interaction times of the patient with the adaptive healing environment;
interaction frequency of the patient with the adaptive healing environment; and
patient's choice of settings of the adaptive healing environment.

5. The healthcare decision support system according to claim 1, wherein the condition data are collected by means of on-body sensors attached to the patient.

6. The healthcare decision support system according to claim 1, wherein the condition data include at least one of heart-rate, blood oxygenation, breathing frequency, activity, blood pressure, temperature or other vital parameters.

7. The healthcare decision support system according to claim 1, wherein the electronic health record data include information on at least one of blood lab values, prescribed medication, symptoms, co-morbidities and medical history.

8. The healthcare decision support system according to claim 1, wherein the patient parameter set includes at least one of
a parameter being indicative of the state-of-mind of a patient;
a parameter being indicative of the alertness of a patient;
information on the resting patterns of a patient;
information on the readiness for discharge of a patient;
a patient health score indicative of the progress of the therapy of a patient; and
information on the risk for adverse events.

9. The healthcare decision support system according to claim 2, wherein evaluating the obtained data and determining the patient parameter set includes comparing the obtained data to historic media stimulation and feedback data, condition data and/or electronic health record data of previous patients and determining irregularities.

10. The healthcare decision support system according to claim 2, wherein evaluating the obtained data and determining the patient parameter set includes using machine learning algorithms based on the obtained data and the historic media stimulation and feedback data, condition data and/or electronic health record data of previous patients.

11. The healthcare decision support system according to claim 1, wherein the medical decision support component comprises a healing environment decision component for controlling the settings of an adaptive healing environment based on the patient parameter set or based on input from medical support personnel and the patient parameter set.

12. The healthcare decision support system according to claim 1, wherein the medical decision support component comprises a clinical decision support component for providing decision support to medical support personnel.

13. A patient care system comprising
an adaptive healing environment for accommodating a patient and for providing media stimulation and feedback data of the patient, said media stimulation and feedback data including information on interactions of the patient with the adaptive healing environment;
a sensor for obtaining condition data of the patient;
an electronic health record database including electronic health record data of the patient;
a healthcare decision support system as claimed in claim 1; and
a medical decision support component for providing decision support to medical personnel and/or to the adaptive healing environment.

14. A healthcare decision support method for providing a patient parameter set for tailoring patient care, said method comprising the steps of
obtaining media stimulation and feedback data of the patient;
obtaining condition data of the patient;
obtaining electronic health record data of the patient;
evaluating the obtained data and determining a patient parameter set including information on the patient; and
providing the patient parameter set to a decision support component;
characterized in that said media stimulation and feedback data include information on interactions of the patient with the adaptive healing environment.

15. A computer-readable non-transitory storage medium containing instructions for execution by a processor, wherein the instructions cause the processor to perform the steps of a method according to claim 14.
